(19) United States
(12) Patent Application Publication
(10) Pub. No.: US 2017/0272810 A1
(43) Pub. Date: Sep. 21, 2017

(54) METHOD FOR UPDATING SERVICE INFORMATION TABLES IN A DIGITAL CONTENT DECODER AND CORRESPONDING DECODER

(71) Applicant: THOMSON LICENSING, Issy les Moulineaux (FR)

(72) Inventors: Bruno CHERON, Noyal sur Vilaine (FR); Francois CHAMPS, Rennes (FR); Olivier MARLEC, La Chapelle des Fougeretz (FR); Bruno LE GARJAN, RENNES (FR)

(21) Appl. No.: 15/500,233

(22) PCT Filed: Jul. 24, 2015
(86) PCT No.: PCT/EP15/66972

§ 371 Date: Jan. 30, 2017

(30) Foreign Application Priority Data
Jul. 30, 2014 (FR) 1457386

(51) Int. Cl. H04N 21/434; H04N 21/84; H04N 21/433; H04N 21/462

(52) U.S. Cl. CPC H04N 21/4345; H04N 21/462; H04N 21/84; H04N 21/433

(57) ABSTRACT

The present disclosure relates to a method for updating service information tables in a digital content decoder comprising: a reception (E1) of a service information table, a filtering (E2) the content of the table to remove or reset to zero, in the table, a table identifier and an item of information unnecessary to the execution of at least one service by the decoder, a calculation (E4) of a hash code relating to an item of information, of the filtered table, a comparison (E5) of the hash code with a hash code relating to an item of information of a previous table, a storage (E6) of said item of information of the table if the hash code of the filtered table and the hash code of the previous table are not identical.

### 1. FIELD

The present disclosure relates to the domain of digital content reception for example digital television and more specifically relates to a method for control of a digital content decoder. More specifically the present disclosure aims to improve update operations for DVB (Digital Video Broadcasting) or ATSC (Advanced Television Systems Committee) standards signalling tables.

### 2. BACKGROUND ART

The present disclosure will more specifically be described in the context of DVB decoders without in any way limiting the scope of the present disclosure to this broadcasting format.

In DVB systems, the decoder is configured to receive channels, or more generally services, using service information contained in tables. These tables are transmitted in the video stream, this stream being able to be diffused by cable, satellite or terrestrial systems. The DVB tables are defined in the standard EN 300 468 V1.11.1.

There are a great number of Service Information (SI) table types. For example there are Network Information Tables (NIT) that provide information of the physical network, Bouquet Association Tables (BAT) that describe the services of a services package, Service Description Tables (SDT) that describe the services of the system and Event Information Tables (EIT) that describe service events. The content of these various tables and their utilisation is described in more detail in the standard EN 300 468 V1.11.1.

These tables are transmitted periodically in carousel in the video stream. The period varies according to the nature of the table. For example the transmission period is 2 seconds for SDT tables. Moreover, these tables are regularly updated, which means that each time the decoder receives a table, it must verify if the table is different from the preceding table stored in the memory and it must store it if it is new.

In the case of a transmission by satellite via a plurality of transponders, each transponder transmits a TS (Transport Stream) in which tables are included. These tables provide not only information on the TS stream, called the actual TS stream, to which the decoder is tuned but also the other TS streams transmitted by the other transponders, called other TS streams. The updates thus relate not only to the actual TS stream but also to the other TS streams. This is equally valid in a terrestrial network or a cable network.

Take for example a satellite transmission via a satellite network comprising 20 transponders and the updating of SDT tables in the decoders. Each transponder transmits in the TS stream an actual SDT table describing the services of this TS stream and 19 other SDT tables describing the services of TS streams transmitted by the 19 other transponders. Thus, when a decoder is linked with a given transponder to display a given programme, the decoder must monitor the actual SDT table but also the 19 other SDT tables to detect any updates of any among them. The decoder in fact needs an updated actual SDT table to correctly execute the services proposed by the actual transponder. Likewise the other SDT tables must be updated to function correctly in the case of service updates on the other transponders. These tables are stored in a non-volatile memory of the decoder.

To detect the updates of these tables, the decoder analyses each of the tables received and detects if they are different from the previous tables.

The detection of differences may be based on a version number. However, this detection is not reliable as the number may differ depending on whether the table is an actual table or an “other” table. Moreover, two tables of different versions may have the same content. This version number difference may then lead to unnecessary updates.

Likewise, the table identity (table_id) is different depending on whether the table is an actual table or an “other” table. The detection of differences therefore cannot be based on this field.

This is why, the detection of differences is currently carried out by comparing the content of the received table with that of the previous table stored in the memory, the update (writing of the new table in the memory) being carried out if the compared contents are different.

The disadvantage of this detection is that it is very consumptive in CPU time as it requires the comparison of numerous complex objects.

### 3. SUMMARY

One purpose of the present disclosure is to propose, in at least some embodiments, a method for updating service information tables in a digital content decoder allowing the previously cited disadvantage to be overcome.

Another purpose of the present disclosure is to propose, in at least some embodiments, a method for updating service information tables in a digital content decoder that is reliable and reduces the number of table updates.

According to the present disclosure, it is proposed to “standardize” the new table before the detection of differences with a previous table. This “standardizing” operation consists in removing or resetting to zero, in the table, certain items of information unnecessary to the execution of services by the decoder, and, possibly, sorting the retained items of information according to a predetermined order.

For this purpose, the present disclosure proposes a method for updating service information tables in a digital content decoder comprising:
receiving (E1) a service information table, called new table,
filtering (E2) a content of the new table to reset to zero or remove, in the new table, at least one table identifier and at least one item of information unnecessary to the execution of at least one service by the decoder.
when a hash code relating to an item of information of the filtered new table differs from a hash code relating to at least one item of information of a previous table, stored (E6) at least said item of information of the filtered new table.

According to a particular embodiment, when the hash code of the filtered new table differs from the hash code of the previous table, the entire new table is stored in the place of the previous table.

According to a specific embodiment, filtering the content of the new table comprises removing or resetting to zero at least one item of information of the table belonging to the following items of information group:
table version numbers, and
unnecessary or non-pertinent fields for the execution of services, such as hash codes.

In some embodiments, all information unnecessary to the execution of services by the decoder are removed or reset to zero. In other embodiments, only some information unnecessary to the execution of services by the decoder can be removed.

Advantageously, the method comprises ordering (or sorting) (E3) items of information of said filtered new table and the hash code of the new table and/or of the previous table relates to ordered items of information. Notably, the items of information can be ordered according to a predetermined order.

According to a particular embodiment, the items of information of said filtered new table comprise loops containing identifiers and ordering said table comprises ordering said loops in an ascending or descending order of identifiers.

While not explicitly described, the embodiments presented can be implemented according to any combination or sub-combination. For example, an embodiment in which the storage comprises the complete replacement of the previous table by the new table can be combined with an embodiment in which the information remaining from the new table are ordered according to a predetermined order before calculation of the hash code.

Other embodiments, which will be considered feasible by persons skilled in the art upon reading the present description, are also included within the scope of the present disclosure.

The present disclosure also relates to a digital content decoder able to implement the method described previously.

More specifically, the present disclosure also relates to a digital content decoder comprising a receiver to receive an audio and/or video stream comprising service information tables, a memory to store the received service information tables and a processor to process said received tables. In particular, for any new received service information table, called new table, the processor is configured for:
filtering a content of the new table to reset to zero or remove, in the new table, at least one table identifier and at least one item of information unnecessary to the execution of at least one service by the decoder,
when a hash code relating to an item of information of the filtered new table differs from a hash code relating to at least one item of information of a previous table, storing at least said item of information of the filtered new table.

According to a particular embodiment, when the hash code of the filtered new table and the hash code of the previous table are not identical, the new table is stored in place of the previous table.

According to a specific embodiment, filtering the content of the new table comprises removing or resetting to zero at least one item of information of the table belonging to the following items of information group:
table version numbers, and
unnecessary or non-pertinent fields for the execution of services, such as hash codes.

According to a particular embodiment, said processor is also configured to order (E3) items of information of said filtered new table and the hash code of the new table and/or of the previous table is relative to ordered items of information.

According to a particular embodiment, the items of information of said filtered new table comprise loops containing identifiers and ordering said table comprises ordering said loops in an ascending or descending order of identifiers.

The present disclosure also relates to a computer programme product comprising programme code instructions for the execution of the method for updating service information tables according to any of the embodiments previously cited, when said programme is executed on a computer.

Finally the present disclosure relates to a recording support comprising a computer programme comprising instructions for the execution of the method for updating service information tables according to any of the embodiments previously cited, when the programme is executed on a computer.

Such a recording support may take the form of a computer programme product loaded onto at least one computer readable storage support comprising computer readable code instructions and that can be executed by computer.

Hence, in the present patent application, a computer readable storage support is considered as being a non-transitory storage support having the intrinsic capacity to store information as well as the intrinsic capacity to allow a restitution of information that it stores.

A computer readable storage support can be for example, but not only, a system, a device or an electronic, magnetic, optical, electromagnetic, infra-red or semi-conductor type equipment implementing a combination of techniques previously cited. It is to be emphasized that the following elements, that provide more specific examples of computer readable storage supports to which the principles of the present disclosure can apply, are essentially cited for illustrative purposes and in no way constitute an exhaustive list, as will be clearly seen by persons skilled in the art: a portable computer diskette, a hardware disk, a ROM (Read Only Memory) type memory, an EPROM (Erasable Programmable Read Only Memory) memory or flash memory, a compact portable disk comprising a ROM memory (CD_ROM), an optical storage device, a magnetic storage device, or any combination adapted from the preceding elements.

As will be clearly understood by persons skilled in the art, aspects of the present disclosure can be implemented by a terminal, a server, a computer programme product or a computer readable storage support. In addition, aspects of the present disclosure can be implemented in some embodiments in the form of entirely hardware components (for example an electronic component or an electronic card equipped with components) or in the form of entirely software components (including for example firmware components, a “resident” application, microcode, etc.). Other embodiments can implement both hardware components and software components. Generally in the present document the term “element” designates a component that can correspond to either a hardware component or a software component. In addition aspects of the present disclosure can be implemented in the form of a computer readable storage support. Any combination of one or more computer readable storage supports can be used.

Other advantages may appear to persons skilled in the art upon reading the examples below, illustrated by the annexes and attached figures, provided for illustrative purposes.

### 4. BRIEF DESCRIPTION OF THE ANNEXES

The following annexes represent portions of SDT tables, according to a particular embodiment of the method of the present disclosure. More specifically:

Annex 1 represents a portion of an actual SDT table relating to services provided via a transponder A,

Annex 2 represents a portion of an other SDT table, to be compared with the table of Annex 1, relating to the services provided via transponder A,

Annex 3 shows the portion of the actual SDT table of Annex 1 after filtering,

Annex 4 shows the portion of the filtered actual SDT table of Annex 3 after sorting of items of information of the table according to a first sorting method, and

Annex 5 shows the portion of the filtered actual SDT table of Annex 3 after sorting of items of information of the table according to a second sorting method.

### 5. BRIEF DESCRIPTION OF THE DRAWINGS

FIG. 1 shows a flow chart of steps of the method of the present disclosure, according to a particular embodiment, and

FIG. 2 shows a diagram of a digital decoder able to implement the method of the present disclosure according to any of its embodiments.

### 6. DESCRIPTION OF EMBODIMENTS

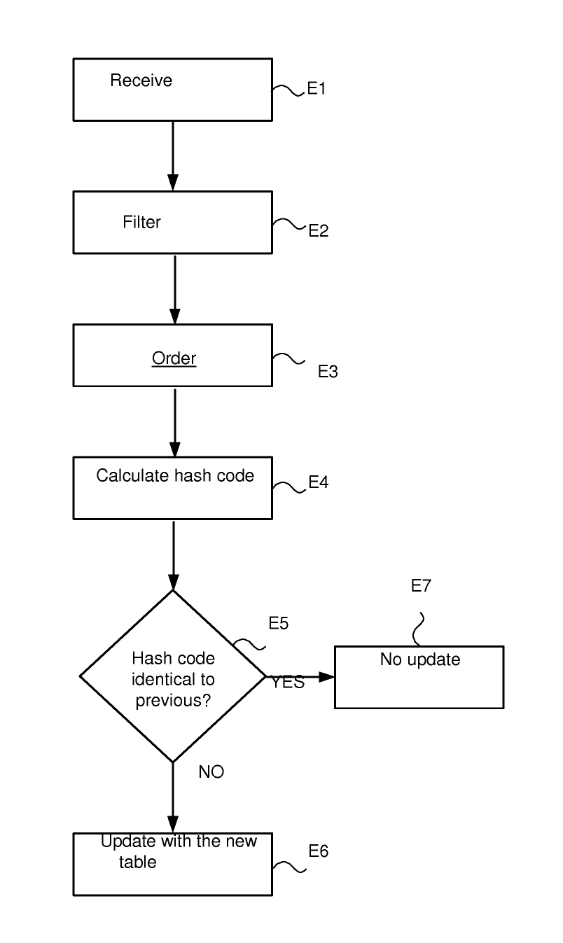

In reference to FIG. 1, the method for updating service information tables in accordance with the present disclosure comprises the following steps.

According to a step E1, the decoder receives a new service information table and must determine if this new table comprises new information justifying a replacement, at least partial, of the table already stored in the decoder.

The received service information table is for example an actual SDT table or an other SDT table both describing services provided by a transponder A. A portion of the actual SDT table is given in Annex 1 and a portion of the corresponding other SDT table is given in Annex 2.

These two annexes describe the first of 5 sections (section_number=0 and last_section_number=4) of the actual SDT table and the other SDT table describing the services of the transport stream TS(111,1) corresponding to transponder A (original_network_id=111 and transport_stream_id=1). Other services of the transport stream TS(111,1) are described in the other sections (not provided) of these two SDT tables.

These two table portions indicate that the transport stream TS(111,1) provides the services 200 and 116 (service_id=200 and service_id=116).

These two portions of table (actual SDT and other SDT) noticeably contain the same items of information. The diverging items of information are the items of information that are underlined in Annex 2. They correspond to the values of certain fields, such as the value of the table identifier (TID) or the version number (version_number). Moreover, the order of the description of services can vary from one table to another. In the example of Annexes 1 and 2, the order of the description of services 116 and 200 is inversed between the two table portions.

According to a particular embodiment of the present disclosure, when a new table is received for the transponder A (transport stream TS(111.1)), it is only stored in the decoder (for example by replacing a table already stored for this transponder in the decoder) if it comprises new items of information modifying the services execution of the transponder.

Hence, according to a particular embodiment of the present disclosure, at a reference step E2, the content of the new received table is filtered to remove or reset to zero at least one item of information unnecessary to the execution of services of the transponder. In some embodiments, all the items of information unnecessary to the execution of services of the transponder can be removed or reset to zero. In other embodiments, only some items of information unnecessary to the execution of services of the transponder can be removed or reset to zero.

In the example of the actual SDT table of Annex 1, all of the fields or descriptors in bold characters placed at the start of the table such as the table identifier (TID), the version number (version_number), etc. can be removed or reset to zero. The hash codes (CRC_32) present in the table as well as the items of information, such as EIT_schedule_flag or EIT_present_following_flag, not pertinent to the execution of services of the transponder can also be removed or reset to zero.

Annex 3 shows the portion of the actual SDT table of Annex 1 after removal of items of information in bold characters.

The order of items of information of the services description may differ from one table to another, advantageously the method comprises, in the particular embodiment presented, a step E3 of sorting of items of information of the filtered table.

According to a first sorting method, the services are sorted in ascending or descending order of their identifiers (service_id) and, within description loops of each of the services, the descriptors are sorted in ascending or descending order of their identifiers (descriptor_tag).

Annex 4 presents the table portion of Annex 3 after sorting of services and descriptors in ascending order of their identifiers.

It should be noted that, in the particular embodiment described, the descriptors “private data specifier descriptor” are particular descriptors that must be considered as loop headers, that is to say all of the descriptors that come after a descriptor “private data specifier descriptor” are considered as being under its scope until the next “private data specifier descriptor” or until the end of the list of descriptors of which it is a part. In the example of Annex 4, that means that the “private descriptor” placed immediately after the descriptor “private data specifier descriptor” of the set EN1 must not be displaced (during the sorting operation) after another descriptor “private data specifier descriptor”.

In the particular embodiment described, in the case where two descriptors have identical identifiers, a hash code is calculated for each of these descriptors and these descriptors are then sorted in ascending or descending order of hash code values. For example in Annex 3, the service 116 comprises two descriptors “private data specifier descriptor” having the same identifiers (descriptor_tag=0x5F), a hash code for the set EN1 of items of information associated with the first descriptor “private data specifier descriptor” and a hash code for the set EN2 of items of information associated with the second “private data specifier descriptor” are then calculated. These two descriptors are then ordered in ascending or descending order of their hash code values.

In Annex 3, it is assumed that the value of the hash code of the set EN1 of items of information associated with the first descriptor “private data specifier descriptor” is greater than that of the hash code of set EN2 of items of information associated with the second descriptor “private data specifier descriptor”. For this reason, these two descriptors are inversed in Annex 4 in which the descriptors are sorted in ascending order of hash code values.

Other sorting methods can be envisaged. According to a second sorting method, the hierarchy of the table descriptor loops is broken by putting them all at the same level of the hierarchy and creating a unique identifier (unique_id) for them from items of information contained in the loop. The descriptor loops are then sorted in ascending or descending order of their unique identifiers. As for the previous sorting method, the set of descriptors are maintained within the scope of a descriptor “private data specifier descriptor”. Preferably, the unique identifier (unique_id) is created from identifiers (service_id, descriptor_tag) contained in the loop. But, if two descriptor loops contain the same identifiers, a hash code is calculated for each of the descriptor loops and this hash code is introduced into the unique identifier as a distinguishing element.

Annex 5 illustrates this second sorting method. Unique identifiers (unique_id) are created for each of the descriptor loops and are ordered in ascending order: 116, 200, (116,0x48), (116,0x54), (116,CRC2), (116,CRC1) and (200,0x48). In this example, it is assumed that CRC1>CRC2.

Naturally, these two sorting methods are provided for illustrative purposes only. Other sorting methods can be envisaged, notably a combination of the two methods described previously.

After the sorting step E3, according to the particular embodiment presented, a hash code relating to at least some of the items of information remaining from the sorted table is calculated in a step E4. This hash code is for example a CRC code.

According to a step E5, this hash code is then compared with a hash code relating to at least some items of information remaining from a corresponding table previously stored in the decoder. If the hash code of the new table and the hash code of the previous table are different, this means that the new table may comprise, with respect to the previous table, new items of information useful in the execution of services. An update of the latter is therefore necessary. In addition, according to a step E6, the previous table is replaced by the new table. According to a particular embodiment, the entire new table is stored in the place of the table previously stored. According to a variant embodiment, only the remaining items of information from the new filtered table, or only those used for the calculation of the hash code are stored.

In the contrary case, when the hash codes are identical (step E7), no update is necessary and the new table can then be destroyed.

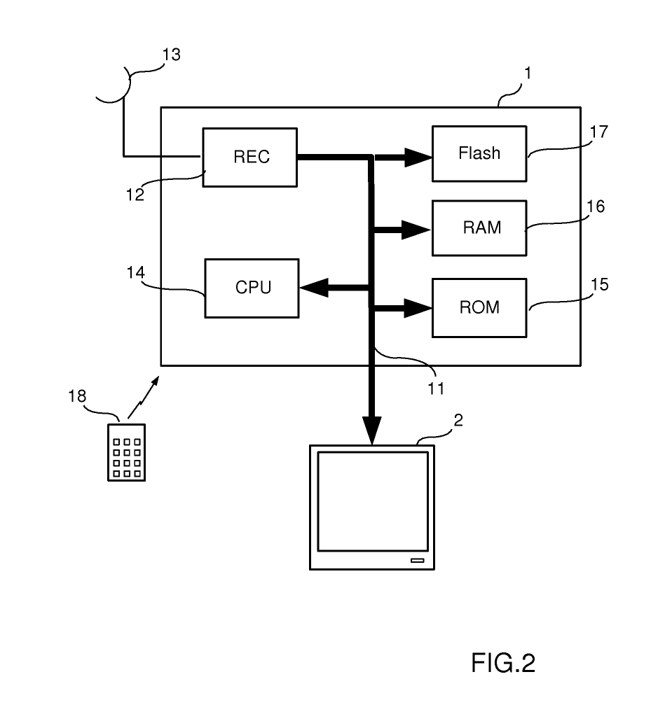

FIG. 2 diagrammatically shows a hardware embodiment of a decoder able to carry out the table update as previously described.

The decoder 1 comprises the following elements, interconnected by a bus 11 of addresses and data:
a video stream receiver 12 connected to an antenna 13 (satellite antenna in the case of a satellite transmission and a rake antenna in the case of an aerial transmission)
a microprocessor 14 (or CPU) to process the video stream data,
a non-volatile memory of ROM (Read Only Memory) type 15,
a RAM (Random Access Memory) non-volatile memory 16,
a non volatile memory of Flash type 17, and
a remote control apparatus 18.

A display device 2 is connected to the decoder 1 via the bus 11 to display items of information of the video stream according to the service selected via the remote control apparatus.

When the decoder is switched-on, the microprocessor 11 loads and executes the instructions of the programme contained in the RAM 16. The RAM 16 notably comprises the operating programme of the microprocessor 11 responsible for switching-on the device 1 and the algorithms necessary for the implementation of the method of the present disclosure. The microprocessor 14 then executes the method of the present disclosure. The tables as well as the hash codes are stored in the Flash memory 17.

Annex 1 (Portion of actual SDT table)

```
Service description section {
  TID =0×42
  section_syntax_indicator = 1
  reserved_future_used = 1
  reserved = 3
  section_length = 830
  transport_stream_id = 1
  reserved = 3
  version_number = 14
  current_next_indicator = 1
```

| | |
|---|---|
| section_number = 0 | /* this section is the first of the table |

describing the services of TS (111,1) */

| | |
|---|---|
| last_section_number = 4 | /* the table is composed of 5 sections */ |

```
  original_network_id = 111
  reserved_future_use = 255
  {
    service_id = 200
    reserved_future_use = 63
    EIT_schedule_flag = 0
    EIT_present_following_flag = 1
    running_status = 4
    free_CA_mode = 0
    descriptors_loop_length = 17
    {
        service descriptor{
          descriptor tag = 0×48 ; descriptor length = 15
          service_type = 1
          service_provider_name_length=0
          service_name_length=12
          service_name=FirstChannel
        }
      }
    service_id = 116
    reserved_future_use = 63
    EIT_schedule_flag = 1
    EIT_present_following_flag = 1
    running_status = 4
    free_CA_mode =1
    descriptors_loop_length = 42
    {
        content descriptor{
          descriptor_tag = 0×54; descriptor_length = 2
          content_nibble_level_1 = 11; content_nibble_level_2 = 0; user_nibble_1 =0 ;
user_nibble_2 = 0
        }
        service descriptor{
          descriptor_tag = 0×48; descriptor_length = 12
          service_type = 1
          service_provider_name_length=0
          service_name_length=9
          service_name=Channel-2
        }
        private_data_specifier descriptor{
          descriptor_tag 0×5F; descriptor length = 4
          11 22 33 44
      }
        private descriptor{
          descriptor_tag 0×EE;descriptor length = 6
          73 11 00 23 00 FC
      }
        private_data_specifier descriptor{
          descriptor_tag 0×5F; descriptor length = 4
          00 11 22 33
      }
        private descriptor{
          descriptor_tag 0×EE;descriptor length = 6
          33 55 00 23 00 00
      }
      CRC_32
    }
```

Annex 2 (Portion of other SOT table)

```
Service description section {
  TID = 0×46
  section_syntax_indicator = 1
  reserved_future_used = 1
  reserved = 3
  section_length = 830
  transport_stream_id = 1
  reserved = 3
  version_number = 13
  current_next_indicator = 1
```

| | |
|---|---|
| section_number = 0 | /* this section is the first of the table |

describing the services of TS (111,1) */

| | |
|---|---|
| last_section_number = 4 | /* the table is composed of 5 sections */ |

```
  original_network_id = 111
  reserved_future_use = 255
  {
    service_id = 116
    reserved_future_use = 63
    EIT_schedule_flag = 0;
    EIT_present_following_flag = 0
    running_status = 4; free_CA_mode = 1
    descriptors_loop_length =42 {
        service descriptor{
          descriptor_tag = 0×48 ;
          descriptor_length = 12
          service_type = 1
          service_provider_name_length=0
          service_name_length=9
          service_name=Channel-2
        }
```

↑↓

```
        content descriptor{
          descriptor_tag = 0×54 ; descriptor_length = 2
          content_nibble_level_1 = 11; content_nibble_level_2 = 0
          user_nibble_1 = 0; user_nibble_2 = 0
        }
        private_data_specifier descriptor{
          descriptor_tag 0×5F; descriptor length = 4
          00 11 22 33
      }
        private descriptor{
          descriptor_tag 0×EE; descriptor length = 6
          33 55 00 23 00 00
      }
```

↑↓

```
        private_data_specifier descriptor{
          descriptor_tag 0×5F; descriptor length = 4
          11 22 33 44
      }
        private descriptor{
          descriptor_tag 0×EE
          descriptor length = 6
          73 11 00 23 00 FC
      }
    }
    service_id = 200
    reserved_future_use = 63
    EIT_schedule_flag = 0;
    EIT_present_following_flag = 0
    running_status = 4;
    free_CA_mode = 0
    descriptors_loop_length = 17 {
        service descriptor {
          descriptor_tag = 0×48; descriptor_length = 15
          service_type = 1
          service_provider_name_length=0
          service_name_length=12
          service_name=FirstChannel
        }
        CRC_32
      }
```

Annex 3
(Portion of the table of Annex 1 after filtering)

| | | |
|---|---|---|
| Service description section { | | |
| service_id = 200 | | |
| reserved_future_use = 63 | | |
| running_status = 4 | | |
| free_CA_mode = 0 | | |
| descriptors_loop_length = 17 { | | |
| service descriptor { | | |
| descriptor_tag = 0×48; descriptor_length = 15 | | |
| service_type = 1 | | |
| service_provider_name_length=0 | | |
| service_name_length=12 | | |
| service_name=FirstChannel | | |
| } | | |
| } | | |
| service_id = 116 | | |
| reserved_future_use = 63 | | |
| running_status = 4 | | |
| free_CA_mode = 1 | | |
| descriptors_loop_length = 42 { | | |
| content descriptor{ | | |
| descriptor_tag = 0×54; descriptor_length = 2 | | |
| content_nibble_level_1 = 11;content_nibble_level_2 = 0; user_nibble_1 = 0 ; | | |
| user_nibble_2 = 0 | | |
| } | | |
| service descriptor{ | | |
| descriptor_tag = 0×48; descriptor_length = 12 | | |
| service_type = 1 | | |
| service_provider_name_length=0 | | |
| service_name_length=9 | | |
| service_name=Channe1-2 | | |
| } | | |
| private_data_specifier descriptor{ | | |
| descriptor_tag 0×5F; descriptor length = 4 | | |
| 11 22 33 44 | | |
| } | {close oversize brace} | /* Set EN1 */ |
| private descriptor{ | | |
| descriptor_tag 0×EE;descriptor length = 6 | | |
| 73 11 00 23 00 FC | | |
| } | | |
| private_data_specifier descriptor{ | | |
| descriptor_tag 0×5F; descriptor length = 4 | | |
| 00 11 22 33 | | |
| } | {close oversize brace} | /* Set EN2 */ |
| private descriptor{ | | |
| descriptor_tag 0×EE;descriptor length = 6 | | |
| 33 55 00 23 00 00 | | |
| } | | |
| } | | |

Annex 4
(Portion of the table of Annex 3
after sorting according to a first method)

| | | |
|---|---|---|
| Service description section { | | |
| service_id = 116 | | |
| reserved_future_use = 0 | | |
| EIT_schedule_flag = 0 | | |
| EIT_present_following_flag = 0 | | |
| running_status = 4 | | |
| free_CA_mode = 1 | | |
| descriptors_loop_length = 42 | | |
| { | | |
| service descriptor{ | | |
| descriptor_tag = 0×48 | | |
| descriptor_length = 12 | | |
| service_type = 1 | | |
| service_provider_name_length=0 | | |
| service_name_length=9 | | |
| service_name=Channel-2 | | |
| } | | |
| content descriptor{ | | |
| descriptor_tag = 0×54 | | |
| descriptor_length = 2 | | |
| content_nibble_level_1 = 11 | | |
| content_nibble_level_2 = 0 | | |
| user_nibble_1 = 0 | | |
| user_nibble_2 = 0 | | |
| } | | |
| private_data_specifier descriptor{ | | |
| descriptor_tag 0×5F | | |
| descriptor length = 4 | | |
| 11 22 33 44 | | |
| } | {close oversize brace} | /* Set EN2 */ |
| private descriptor{ | | |
| descriptor_tag 0×EE | | |
| descriptor length = 6 | | |
| 73 11 00 23 00 FC | | |
| } | | |
| private_data_specifier descriptor{ | | |
| descriptor_tag 0×5F | | |
| descriptor length = 4 | | |
| 00 11 22 33 : | | |
| } | {close oversize brace} | /* Set EN1 */ |
| private descriptor{ | | |
| descriptor_tag 0×EE | | |
| descriptor length = 6 | | |
| 33 55 00 23 00 00 | | |
| } | | |
| service_id = 200 | | |
| reserved_future_use = 0 | | |
| EIT_schedule_flag = 0 | | |
| EIT_present_following_flag = 0 | | |
| running_status = 4 | | |
| free_CA_mode = 0 | | |
| descriptors_loop_length = 17 | | |
| { | | |
| service descriptor{ | | |
| descriptor_tag = 0×48 | | |
| descriptor_length = 15 | | |
| service_type = 1 | | |
| service_provider_name_length=0 | | |
| service_name_length=12 | | |
| service_name=FirstChannel | | |
| } | | |
| } | | |
| } | | |

Annex 5
(Portion of the table of Annex 3
after sorting according to a second method)

| | | |
|---|---|---|
| service_id = 116 | | /* unique_id : 116 * / |
| reserved_future_use = 0 | | |
| running_status = 4 | | |
| free_CA_mode = 1 | | |
| service_id = 200 | | /* unique_id : 200 * / |
| reserved_future_use = 0 | | |
| running_status = 4 | | |
| free_CA_mode = 0 | | |
| service descriptor{ | | /* unique_id : (116, 0×48) * / |
| descriptor_tag = 0×48 | | |
| descriptor_length = 12 | | |
| service_type = 1 | | |
| service_provider_name_ length=0 | | |
| service_name_length=9 | | |
| service_name=Channel-2 | | |
| } | | |
| content descriptor{ | | /* unique_id : (116, 0×54) * / |
| descriptor_tag = 0×54 | | |
| descriptor_length = 2 | | |
| content_nibble_level_1 = 11 | | |
| content_nibble_level_2 = 0 | | |
| user_nibble_1 = 0 | | |
| user_nibble_2 = 0 | | |
| } | | |
| private_data_specifier_descriptor{ | | /* unique_id : (116, CRC2) * / |
| descriptor_tag 0×5F | | |
| descriptor length = 4 | | |
| 11 22 33 44 | | |
| } | {close oversize brace} | /* Set EN2 - CRC2*/ |
| private descriptor{ | | |
| descriptor_tag 0×EE | | |
| descriptor length = 6 | | |
| 73 11 00 23 00 FC | | |
| } | | |
| private_data_specifier_descriptor{ | | /* unique_id : (116, CRC1) * / |
| descriptor_tag 0×5F | | |
| descriptor length = 4 | | |
| 00 11 22 33 | | |
| } | {close oversize brace} | /* Set EN1 - CRC1*/ |
| private descriptor{ | | |
| descriptor_tag 0×EE | | |
| descriptor length =6 | | |
| 33 55 00 23 00 00 | | |
| } | | |
| service descriptor{ | | /* unique_id : (200, 0×48) * / |
| descriptor_tag = 0×48 | | |
| descriptor_length = 15 | | |
| service_type = 1 | | |
| service_provider_name_ length=0 | | |
| service_ name_length=12 | | |
| service_ name=FirstChannel | | |
| } | | |

1. A method for updating service information tables stored in a digital content decoder, each of said service information table comprising service information items, said method comprising:
receiving a service information table being of a same type as a stored service information table, said received service information table comprising at least one table identifier and service information items, at least one first of said service information items being unnecessary to an execution of at least one service by the digital content decoder;
filtering a content of the received service information table, said filtering including removing or resetting to zero, in the received service information table, said table identifier and said first service information item,
when a hash code, relating to all service information items of the filtered service information table, differs from a hash code relating to all service information items of said stored service information table, storing said service information items of the filtered service information table.

2. The method according to claim 1, wherein, when the hash code of the filtered service information table differs from the hash code of the stored service information table, the filtered service information table is stored in the place of the stored service information table.

3. The method according to claim 1, wherein filtering the content of the received service information table comprises removing or resetting to zero at least one service information item of the received service information table belonging to the following items of information group:
table version numbers, and
unnecessary or non-pertinent fields for the execution of services, such as hash codes.

4. The method according to claim 1, wherein ordering the service information items of said filtered service information table and wherein the hash code of the filtered service information table and/or of the stored service information table relates to ordered items of information.

5. The method according to claim 4, wherein the service information items of said filtered service information table comprise loops containing identifiers and wherein ordering said filtered service information table comprises ordering said loops in ascending or descending order of identifiers.

6. A digital content decoder comprising a receiver to receive an audio and/or video stream comprising service information tables, each of said service information table comprising service information items, a memory to store the received service information tables and a processor to process said received service information tables, wherein the processor is configured for:
receiving a service information table being of a same type as a stored service information table, said received service information table comprising at least one table identifier and service information items, at least one first of said service information items being unnecessary to an execution of at least one service by the digital content decoder;
filtering a content of the received service information table, said filtering including removing or resetting to zero, in the received service information table, said table identifier and said first service information item,
when a hash code, relating to all service information items of the filtered service information table differs from a hash code relating to all service information of said stored service information table, storing at least said service information items of the filtered service information table.

7. The digital content decoder according to claim 6, wherein, when the hash code of the filtered service information table and the hash code of the stored service information table are not identical, the filtered service information table is stored in the place of the stored service information table.

8. The digital content decoder according to claim 6, wherein filtering the content of the received service information table comprises removing or resetting to zero at least one item of information of the received service information table belonging to the following items of information group:
table version numbers, and
unnecessary or non-pertinent fields for the execution of services, such as hash codes.

9. The digital content decoder according to claim 6, wherein said processor is configured to order items of information of said filtered service information table and wherein the hash code of the filtered service information table and/or of the stored service information table relates to ordered items of information.

10. The digital content decoder according to claim 9, wherein the items of information of said filtered service information table comprise loops containing identifiers and wherein ordering said filtered service information table comprises ordering said loops in ascending or descending order of identifiers.

11. Computer program product comprising program code instructions for executing, when said program is executed on a computer, a method for updating service information tables stored in a digital content decoder, each of said service information table comprising service information items, said method comprising:
receiving a service information table being of a same type as a stored service information table, said received service information table comprising at least one table identifier and service information items, at least one first of said service information items being unnecessary to an execution of at least one service by the digital content decoder;
filtering a content of the received service information table, said filtering including removing or resetting to zero, in the received service information table, said table identifier and said first service information item,
when a hash code, relating to all service information items of the filtered service information table differs from a hash code relating to all service information items of said stored service information table, storing said service information items of the filtered service information table.

12. Recording support comprising a computer program comprising instructions for executing the method for updating service information tables according to claim 1.
